(19) United States
(12) Patent Application Publication
(10) Pub. No.: US 2012/0308066 A1
(43) Pub. Date: Dec. 6, 2012

(54) COMBINED MICRO-ELECTRO-MECHANICAL SYSTEMS MICROPHONE AND METHOD FOR MANUFACTURING THE SAME

(76) Inventors: Hung-Jen CHEN, Taichung (TW); Kuan-Hsun Chiu, Taichung (TW); Kuo-Hsiang Li, Taichung (TW); Yung-Ta Chen, Taichung (TW)

(21) Appl. No.: 13/153,121

(22) Filed: Jun. 3, 2011

(51) Int. Cl. H04R 1/00; H04R 31/00

(52) U.S. Cl. 381/369; 29/594

(57) ABSTRACT

A combined MicroElectroMechanical Systems (MEMS) microphone includes a first substrate, a second substrate, a vibrating diaphragm, a backplate, and an accommodating slot. The first substrate has a first chamber, the vibrating diaphragm is disposed on the first chamber, the second substrate has a second chamber, one side of the backplate is disposed on the second chamber, and the other side of the backplate is disposed on the vibrating diaphragm, so that the second substrate is combined with the first substrate. In addition, the backplate has multiple sound holes, and the accommodating slot is disposed between the first substrate and the second substrate to form a space between the vibrating diaphragm and the backplate.

### BACKGROUND OF THE INVENTION

1. Field of Invention

The present invention relates to a Micro-Electro-Mechanical Systems (MEMS) microphone, and more particularly to a combined MEMS microphone and a method for manufacturing the same.

2. Related Art

As a product being greatly developed in the electro-acoustic industry in recent years, an MEMS microphone may be widely applicable to various portable electronic devices, which satisfies a miniaturization and acoustic reception effect.

FIG. 1 is a schematic view of a conventional MEMS microphone. Referring to FIG. 1, the conventional MEMS microphone includes a first chip 1 and a second chip 2 disposed on the first chip 1. A vibrating diaphragm 3 is disposed on the first chip 1, and the second chip 2 is disposed with a backplate 4 corresponding to the vibrating diaphragm 3. A support structure 5 is disposed between the first chip 1 and the second chip 2 to receive the vibrating diaphragm 3, so as to keep the vibrating diaphragm 3 within an area defined by the support structure 5 without being affected by a stress. The support structure 5 is mainly disposed in a slot 6 of the backplate 4.

However, a height of the support structure 5 must precisely match a depth of the slot 6; otherwise, after the first chip 1 is combined with the second chip 2, the support structure 5 is easily deformed or damaged by an acting pressure during the combination so that the structure makes it very difficult to control production yield rates. In addition, in a method in which the support structure 5 is directly combined with the second chip 2, it is necessary to consider whether a eutectic reaction can occur between a material of the support structure 5 and a Si-layer of the second chip 2, thereby making selection of materials very limited. Furthermore, the vibrating diaphragm 3 of the conventional MEMS microphone is a floating structure, so that a sacrificial layer is normally required to be adopted in a manufacturing process, and implementation of the manufacturing process is not easy.

### SUMMARY OF THE INVENTION

Accordingly, the present invention is directed to a combined MEMS microphone and a method for manufacturing the same, in which a central portion of a vibrating diaphragm of the combined MEMS microphone is accommodated in an accommodating slot pre-formed on a substrate, thereby protecting the vibrating diaphragm in the slot and increasing overall structural strength accordingly.

In order to achieve the objective, the present invention provides a combined MEMS microphone, which comprises a first substrate, a second substrate, a vibrating diaphragm, a backplate, and an accommodating slot. The first substrate has a first chamber, the vibrating diaphragm is disposed on the first chamber, the second substrate has a second chamber, one side of the backplate is disposed on the second chamber, and the other side of the backplate is disposed on the vibrating diaphragm, so that the second substrate is combined with the first substrate. The backplate has multiple sound holes. The accommodating slot is disposed between the first substrate and the second substrate to form a space between the vibrating diaphragm and the backplate. Therefore, when the accommodating slot is disposed in the first substrate, a central portion of the vibrating diaphragm is able to be accommodated in the accommodating slot, thereby protecting the vibrating diaphragm in the slot and increasing overall structural strength. Meanwhile, through the design of the accommodating slot, an overall height is decreased, thereby facilitating achieving an objective of miniaturization.

In order to achieve the objective, the present invention provides a method for manufacturing a combined MEMS microphone, which comprises: providing a first substrate, in which an accommodating slot is manufactured in the first substrate, a vibrating diaphragm is manufactured on the first substrate, and a central portion of the vibrating diaphragm is accommodated in the accommodating slot; providing a second substrate, in which a backplate having multiple sound holes is manufactured on the second substrate; combining the first substrate and the second substrate to form a space between the vibrating diaphragm and the backplate; removing two sides of the second substrate to expose the first substrate; manufacturing a first chamber on the first substrate and manufacturing a second chamber on the second substrate; and removing two sides of the first substrate in a mechanical manner to manufacture a combined MEMS microphone.

In order to achieve the objective, in the present invention, the accommodating slot may also be disposed in the second substrate to accommodate the central portion of the backplate to protect the structure of the backplate.

In order to achieve the objective, in the present invention, a side edge of the first substrate or the second substrate may be manufactured with a slot structure, so that during a cutting process in the mechanical manner, the slot structure is used as an area where the cutting stops, and a cutting depth is not required to exceed a thickness of a conventional structure, thereby reducing the manufacturing time and increasing production yield rates.

In order to achieve the objective, in the present invention, the backplate is manufactured on the second substrate, the backplate may also be manufactured with multiple sound holes in a chemical manner at the same time, and when the second chamber is formed in the second substrate, the two sides of the second substrate are removed, thereby simplifying the manufacturing process.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a conventional MEMS microphone;

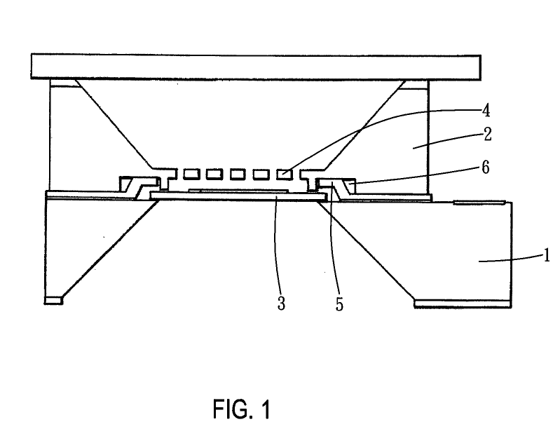

FIG. 2 is a schematic view of a vibrating diaphragm formed on a first substrate according to a first embodiment of the present invention;

FIG. 3 is a schematic view of a backplate formed on a second substrate according to the first embodiment of the present invention;

FIG. 4 is a schematic view of combination of two substrates according to the first embodiment of the present invention;

FIG. 5 is a schematic view of cutting a second substrate according to the first embodiment of the present invention;

FIG. 6 is a schematic view of steps of another manufacturing process according to the first embodiment of the present invention;

FIG. 7 is a schematic view of formation of a chamber structure according to the first embodiment of the present invention;

FIG. 8 is a schematic view of cutting a first substrate according to the first embodiment of the present invention; and

FIG. 9 is a schematic view of a second embodiment of the present invention.

### DETAILED DESCRIPTION OF THE INVENTION

Embodiments of a combined MEMS microphone and a method for manufacturing the same of the present invention are described below with reference to the accompanying figures.

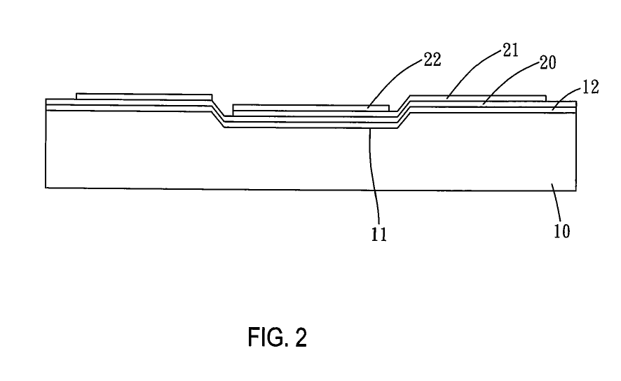

FIG. 2 is a schematic view of a vibrating diaphragm formed on a first substrate according to a first embodiment of the present invention. Referring to FIG. 2, first, the first substrate 10 made of Si is provided, and an upper surface thereof is etched with a rectangular accommodating slot 11. A first insulating layer 12 is deposited on the upper surface of the first substrate 10, in which the first insulating layer 12 is deposited on the upper surface of the first substrate 10 and the accommodating slot 11. The first insulating layer 12 is made of silicon dioxide (SiO₂). Next, a vibrating diaphragm 20 is deposited on the first insulating layer 12, and may be made of silicon nitride (SiNₓ) or a metal. A central area of the vibrating diaphragm 20 rightly sinks in the accommodating slot 11. In addition, a conductive layer 21 is deposited on the vibrating diaphragm 20, and a second insulating layer 22 is further deposited on a portion of the conductive layer 21 located on a central portion of the vibrating diaphragm 20, and the second insulating layer 22 may be made of SiO₂ or other insulating materials. In addition, the two sides of the conductive layer are used as wire bonding areas.

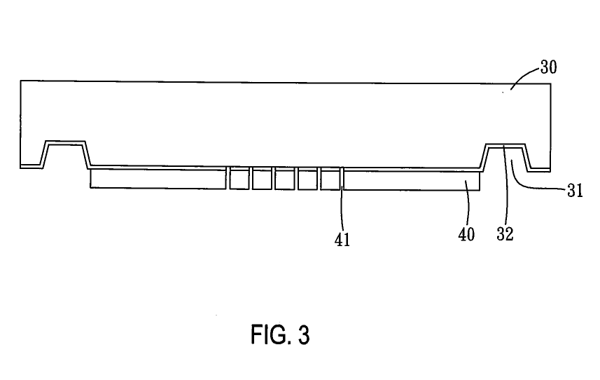

FIG. 3 is a schematic view of a backplate formed on a second substrate according to the first embodiment of the present invention. Referring to FIG. 3, the second substrate 30 is provided, which is made of Si, and two sides of a lower surface of the second substrate 30 are respectively etched with a slot structure 31. The slot structure 31 may be of any geometric shape, such as rectangle, trapezium, or round. A third insulating layer 32 is deposited on the lower surface of the second substrate 30, in which the third insulating layer 32 is made of SiO₂, and is deposited on the slot structure 31 and the lower surface of the second substrate 30. In addition, the backplate 40 having sound holes 41 is manufactured in a flat central area of the lower surface of the second substrate 30.

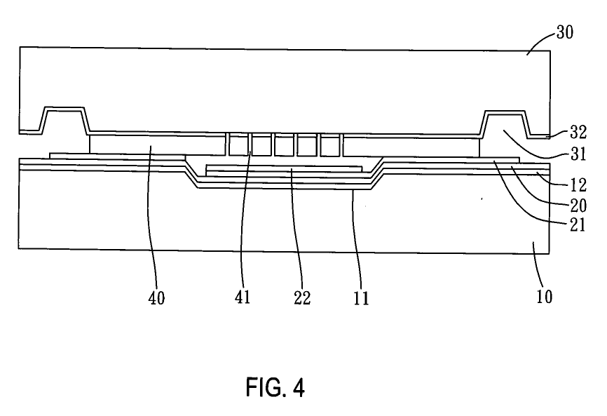

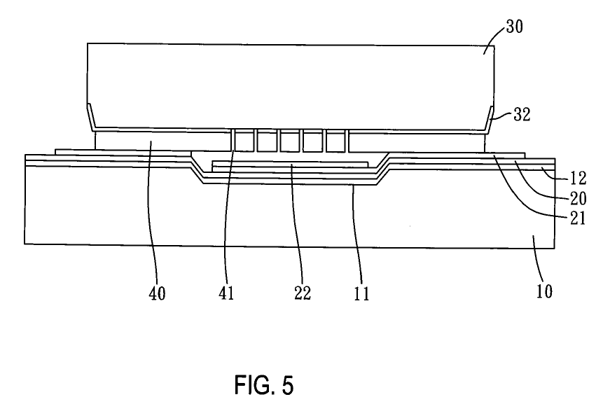

FIG. 4 is a schematic view of combination of the two substrates according to the first embodiment of the present invention. Referring to FIG. 4, the second substrate 30 is combined with the conductive layer 21 of the first substrate 10 through the backplate 40, so as to form an adequate space between the vibrating diaphragm 20 and the backplate 40. The combination of the first substrate 10 and the second substrate 30 may be implemented by binding, melting, anodic bonding, gluing, thermosonic bonding, or other similar combination manners. The adequate space is defined according to a depth of the accommodating slot 11, and due to design of the accommodating slot 11 of the first substrate 10, a depth of the first substrate 10 and the second substrate 30 of the present invention after the combination is smaller than that of a conventional MEMS microphone, thereby facilitating product miniaturization. Referring to FIG. 5, cutting is respectively performed in the area of the slot structure 31 of the second substrate 30 in a mechanical cutting manner to make the slot structure 31 be the area where the cutting stops; thus the second substrate 30 is separated from a wafer, and is manufactured into predetermined dimensions, and the conductive layer 21 of the first substrate 10 is exposed for wire bonding. The slot structure 31 of the present invention is pre-formed, so that a cutting depth of the second substrate 30 is not required to exceed an overall thickness, thereby effectively reducing the manufacturing time and increasing production yield rates. Accordingly, the slot structure 31 of the present invention may also be applied to the first substrate 10 according to manufacturing needs, and achieve the same effect. In addition, it should be noted that if a chemical manner is adopted in the manufacturing process of separating the second substrate 30 from the wafer, the second substrate 30 can be combined with the first substrate 10 directly, thereby saving a step of cutting the second substrate 30, so as to facilitate simplifying the manufacturing process.

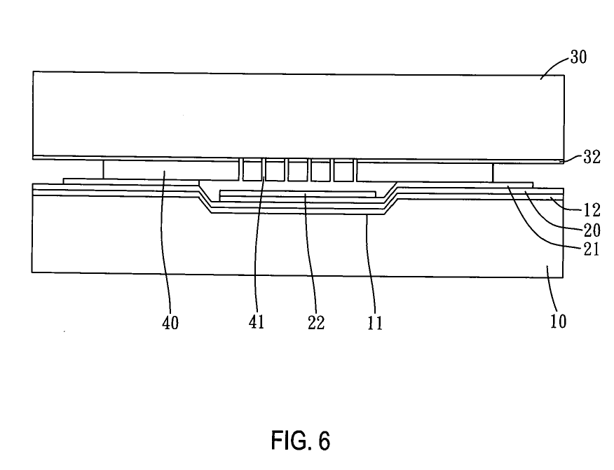

FIG. 6 is a schematic view of steps of another manufacturing process according to the first embodiment of the present invention. Referring to FIG. 6, the second substrate 30 without being disposed with the slot structure is provided, and is combined with the first substrate 10.

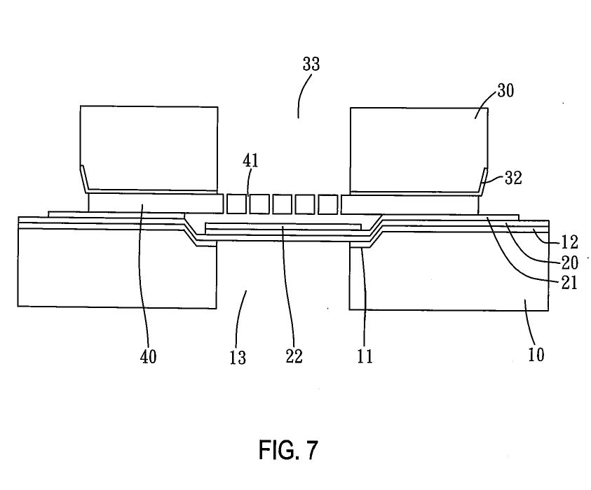

FIG. 7 is a schematic view of formation of a chamber structure according to the first embodiment of the present invention. Referring to FIG. 7, a back portion of the first substrate 10 is formed with a first chamber 13, a back portion of the second substrate 30 is formed with a second chamber 33, which are in communication with the space between the vibrating diaphragm 20 and the backplate 40, so that the vibrating diaphragm 20 is formed to be a suspended structure. If the steps of the manufacturing process of FIG. 6 are adopted, when the second chamber 33 is manufactured, the two sides of the second substrate 30 are etched, so that the second substrate 30 is separated from the wafer, which is different from the aforementioned steps of manufacturing the slot structure 31.

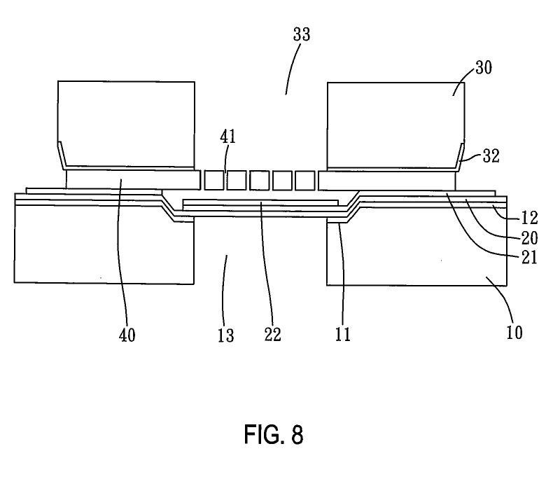

FIG. 8 is a schematic view of cutting the first substrate according to the first embodiment of the present invention. Referring to FIG. 8, at the end of the manufacturing process, two sides of the first substrate 10 are cut in a mechanical manner to separate the first substrate 10 from a wafer. Since the second substrate 30 has been cut in the previous process to separate from the wafer, the total cutting process for forming a combined MEMS microphone of the present invention is performed twice Therefore, for the MEMS microphone of the present invention, the product yield rate may not be decreased as compared to that of the conventional MEMS microphones required to cut deeply and the manufacturing process is simple and not limited by cutting tools. If the manufacturing process of separating the second substrate 30 from the wafer in the chemical manner is adopted, the two sides of the first substrate 10 are only required to be cut directly, thereby avoiding unnecessary influences in the manufacturing process. In addition, electronic components may be disposed on an upper surface of the second substrate 30 according to requirements of an electronic product, and the electronic components may include capacitors, resistors, inductors, and integrated chips.

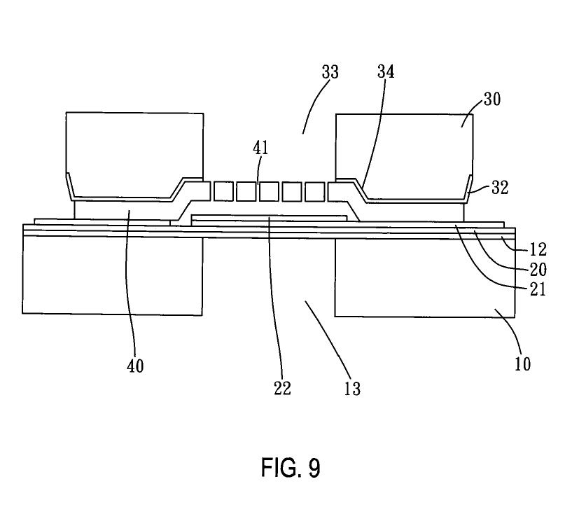

FIG. 9 is a schematic view of a second embodiment of the present invention. Referring to FIG. 9, a difference between this embodiment and the aforementioned embodiment lies in that in this embodiment the accommodating slot 34 is changed to be disposed on the second substrate 30, so that a central portion of the backplate 40 sinks in the accommodating slot 34, thereby achieving the same effect of the aforementioned manufacturing process.

In the combined MEMS microphone and the method for manufacturing the same of the present invention, the first substrate is etched with an accommodating slot to accommodate the central portion of the vibrating diaphragm, so that the vibrating diaphragm is protected in the accommodating slot, thereby achieving better overall structural strength. In addition, the depth of the accommodating slot decides a distance between the backplate of the second substrate and the vibrating diaphragm, so that the height of the combined first substrate and second substrate is smaller than that of the conventional structure, thereby achieving the objective of miniaturization. In addition, in the present invention, the accommodating slot may also be changed to be disposed on the second substrate to accommodate the central portion of the backplate, thereby also achieving the effect of protecting the backplate.

In the method for manufacturing the combined MEMS microphone of the present invention, the two sides of the second substrate are etched with the slot structure, so that in the present invention, when the second substrate is cut, the slot structure is where the cutting stops, so that the cutting depth is not required to exceed the thickness of the second substrate, thereby reducing the overall manufacturing time, avoiding influences of parameters of cutting tools, and increasing the product yield rate. In addition, the slot structures of the present invention may also be disposed in the two sides of the first substrate to achieve the same effect as aforementioned.

In addition, in the method for manufacturing the combined MEMS microphone of the present invention, after the second substrate is combined with the first substrate, and when the second chamber is manufactured in the second substrate, the two sides are removed from the wafer by etching, thereby achieving an effect of simplifying a subsequent manufacturing process.

The above descriptions are only exemplary, and are not used to limit the present invention. Equivalent modifications and alterations made without departing from the spirit and scope of the present invention are all covered by the claims of the present invention.

What is claimed is:

1. A combined MicroElectroMechanical Systems (MEMS) microphone, comprising:
a first substrate, having a first chamber;
a vibrating diaphragm, disposed on the first chamber;
a second substrate, having a second chamber;
a backplate, wherein one side of the backplate is disposed on the second chamber, the other side of the backplate is disposed on the vibrating diaphragm, so that the second substrate is combined with the first substrate, and the backplate has multiple sound holes; and
an accommodating slot, disposed between the first substrate and the second substrate to form a space between the vibrating diaphragm and the backplate.

2. The combined MEMS microphone according to claim 1, wherein the accommodating slot is disposed in the first substrate, and is in communication with the first chamber, so as to accommodate a central portion of the vibrating diaphragm.

3. The combined MEMS microphone according to claim 1, wherein the accommodating slot is disposed in the second substrate, and is in communication with the second chamber, so as to accommodate a central portion of the backplate.

4. The combined MEMS microphone according to claim 1, wherein a conductive layer is disposed on the vibrating diaphragm, and two sides of the conductive layer are used as wire bonding areas, and the conductive layer is disposed between the backplate and the vibrating diaphragm.

5. The combined MEMS microphone according to claim 1, wherein a first insulating layer made of silicon dioxide (SiO₂) is disposed between the vibrating diaphragm and the first substrate.

6. The combined MEMS microphone according to claim 1, wherein a second insulating layer is disposed on the vibrating diaphragm.

7. The combined MEMS microphone according to claim 1, wherein a third insulating layer made of SiO₂ is disposed between the backplate and the second substrate.

8. The combined MEMS microphone according to claim 1, wherein the vibrating diaphragm is made of silicon nitride (SiNₓ).

9. A method for manufacturing a combined MicroElectroMechanical Systems (MEMS) microphone, comprising:
providing a first substrate, wherein an accommodating slot is manufactured in the first substrate, a vibrating diaphragm is manufactured on the first substrate, and a central portion of the vibrating diaphragm is accommodated in the accommodating slot;
providing a second substrate, wherein a backplate having multiple sound holes is manufactured on the second substrate;
combining the first substrate and the second substrate to form a space between the vibrating diaphragm and the backplate;
removing two sides of the second substrate to expose the first substrate;
manufacturing a first chamber in the first substrate, and manufacturing a second chamber in the second substrate; and
removing two sides of the first substrate in a mechanical manner to manufacture the combined MEMS microphone.

10. The method for manufacturing a combined MEMS microphone according to claim 9, wherein a slot structure is manufactured in a side edge of the first substrate or a side edge of the second substrate.

11. The method for manufacturing a combined MEMS microphone according to claim 10, wherein the slot structure is formed by etching.

12. The method for manufacturing a combined MEMS microphone according to claim 9, wherein the accommodating slot is formed by etching.

13. The method for manufacturing a combined MEMS microphone according to claim 9, wherein the two sides of the second substrate are removed in the mechanical manner.

14. A method for manufacturing a combined MicroElectroMechanical Systems (MEMS) microphone, comprising:
providing a first substrate, wherein a vibrating diaphragm is manufactured on the first substrate;
providing a second substrate, wherein an accommodating slot is manufactured in the second substrate, a backplate having multiple sound holes is manufactured on the second substrate, and a central portion of the backplate is accommodated in the accommodating slot;
combining the first substrate and the second substrate to form a space between the vibrating diaphragm and the backplate;
removing two sides of the second substrate to expose the first substrate;
manufacturing a first chamber in the first substrate, and manufacturing a second chamber in the second substrate; and
cutting two sides of the first substrate in a mechanical manner to manufacture the combined MEMS microphone.

15. The method for manufacturing a combined MEMS microphone according to claim 14, wherein a slot structure is manufactured in a side edge of the first substrate or a side edge of the second substrate.

16. The method for manufacturing a combined MEMS microphone according to claim 15, wherein the slot structure is formed by etching.

17. The method for manufacturing a combined MEMS microphone according to claim 14, wherein the accommodating slot is formed by etching.

18. The method for manufacturing a combined MEMS microphone according to claim 14, wherein the two sides of the second substrate are removed in the mechanical manner.

19. A method for manufacturing a combined MicroElectroMechanical Systems (MEMS) microphone, comprising:
providing a first substrate, wherein an accommodating slot is etched in the first substrate, a vibrating diaphragm is manufactured on the first substrate, and a central portion of the vibrating diaphragm is accommodated in the accommodating slot;
providing a second substrate, wherein a backplate having multiple sound holes is manufactured on the second substrate;
combining the first substrate and the second substrate to form a space between the vibrating diaphragm and the backplate;
manufacturing a first chamber in the first substrate, and manufacturing a second chamber in the second substrate and at the same time removing two sides of the second substrate; and
cutting two sides of the first substrate in a mechanical manner to manufacture the combined MEMS microphone.

20. A method for manufacturing a combined MicroElectroMechanical Systems (MEMS) microphone, comprising:
providing a first substrate, wherein a vibrating diaphragm is manufactured on the first substrate;
providing a second substrate, wherein an accommodating slot is etched in the second substrate;
manufacturing a backplate having multiple sound holes on the second substrate, thereby accommodating a central portion of the backplate in the accommodating slot;
combining the first substrate and the second substrate to form a space between the vibrating diaphragm and the backplate;
manufacturing a first chamber in the first substrate, and manufacturing a second chamber in the second substrate and at the same time removing two sides of the second substrate; and
cutting two sides of the first substrate in a mechanical manner to manufacture the combined MEMS microphone.
